(19) United States
(12) Patent Application Publication
(10) Pub. No.: US 2025/0294411 A1
(43) Pub. Date: Sep. 18, 2025

(54) REAL-TIME TEXT CONTINUITY AFTER HANDOVER

(71) Applicant: GOOGLE LLC, Mountain View, CA (US)

(72) Inventors: Jose Andres Cesares Cano, Nuremberg (DE); Shi Lu, Cupertino, CA (US)

(21) Appl. No.: 18/605,114

(22) Filed: Mar. 14, 2024

(51) Int. Cl. H04W 36/00; H04L 65/1095; H04L 65/65; H04W 36/02; H04W 36/14

(52) U.S. Cl. CPC H04W 36/0011; H04L 65/1095; H04L 65/65; H04W 36/02; H04W 36/1446

(57) ABSTRACT

A mobile device is configured to perform a method for continuing a Real-time Text (RTT) session during a handover from a first radio access network to a second radio access network. The method includes, after detecting a handover from the first radio access network to the second radio access network during the RTT session between the mobile device and another device, estimating a sequence number associated with the second radio access network after the handover and continuing the RTT session on the second radio access network based on the estimated sequence number.

### BACKGROUND

Some mobile devices support Real-Time Text (RTT) as a feature for accessibility (e.g., to generate text of an audio call for the hearing impaired) and emergency situations. RTT is text that is transmitted effectively instantly as it is typed or created such that the recipient of the RTT can read the message while it is being generated by the sender. Mobile devices often seek to maintain RTT session continuity when switching between different types of radio access networks.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of a mobile device with a dual real-time transport protocol (RTP) stack architecture in accordance with some embodiments.

FIG. 2 shows an example of a radio access network depicting a handover event for a mobile device in accordance with some embodiments.

FIG. 3 shows an example of a message sequence chart (MSC) to maintain RTT session continuity after handover in accordance with some embodiments.

FIG. 4 shows an example of an RTP packet header in accordance with some embodiments.

FIG. 5 shows an example of a RTP Control Protocol (RTCP) receiver report in accordance with some embodiments.

FIG. 6 shows an example method flowchart for a mobile device to continue an ongoing RTT session after handover from a first radio access network to a second radio access network in accordance with some embodiments.

### DETAILED DESCRIPTION

Modern mobile devices (e.g., user equipment (UE)) typically support communications over multiple radio interfaces. For example, it is common for mobile devices to communicate over cellular networks such as networks based on the Third Generation Partnership Project (3GPP) Fifth Generation New Radio (5G NR) or 3GPP Fourth Generation Long Term Evolution (4G LTE) standards and over wireless local-area networks (WLANs) such as WiFi. In some cases, a mobile device may switch from coverage on one type of radio access network (e.g., WLAN) to coverage on another type of radio access network (e.g., an 4G LTE or 5G NR network) during an RTT session due to the mobile device moving between different coverage areas or the signal quality of a current coverage area falling below a signal quality threshold. This switching from one type of radio access network to another type of radio access network is referred to as a handover between radio interfaces, or simply “handover” for purposes of brevity. Mobile devices typically seek to support RTT service continuity when there is a such a handover. For instance, an RTT session should not be interrupted or dropped if it is initially being conducted over Voice over WiFi (VoWiFi) and subsequently handed over to Voice over LTE (VOLTE). However, conventional methods for performing a handover from a first radio access network type (e.g., WiFi) to a second radio access network type (e.g., 4G LTE) sometimes result in RTT service discontinuity or the RTT session being completely dropped. These discontinuities or interruptions are more common when at least one of the mobile devices in the RTT session has a dual real-time transport protocol (RTP) stack architecture without a standard interface to synchronize the RTP stacks associated with the radio access networks before and after the handover (such a device is referred to herein as an unsynchronized dual RTP stack device). The RTT discontinuities or interruptions are attributed to a large RTT sequence number (SN) jump when handing over the RTT session from the first radio access network to the second radio access network.

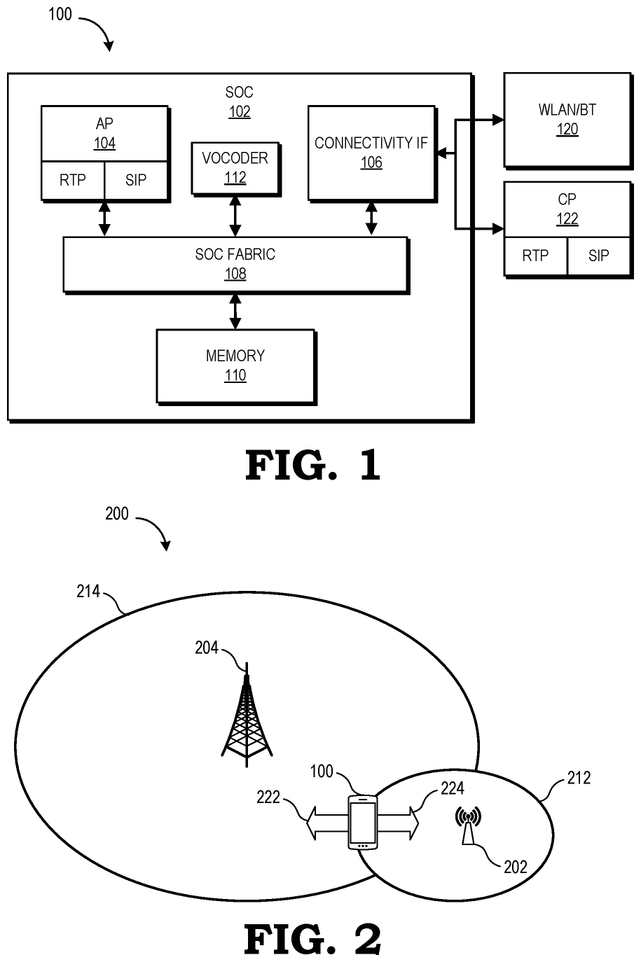

FIGS. 1-6 provide systems and techniques for maintaining continuity of a RTT session after a handover between different types of radio access networks. This approach can result in fewer dropped RTT sessions, thereby improving user experience. To illustrate, in some embodiments, a method includes conducting an RTT session between a first mobile device and a second mobile device when the first device is connected to a first radio access network, e.g., to a WLAN network such as WiFi. During the RTT session, a handover is triggered from the first radio access network to a second radio access network (e.g., an LTE or 5G network). For example, the handover may be triggered based on the first mobile device moving out of range of the first radio access network or the signal quality of the first radio access network falling below a threshold. In response to the handover starting, the first mobile device estimates a sequence number that is associated with the second radio access network directly after the handover and continues the RTT session on the second radio access network after the handover based on the estimated sequence number.

In some embodiments, any of the elements, components, or blocks shown in the ensuing figures are implemented as one of software executing on a processor, hardware that is hard-wired (e.g., circuitry) to perform the various operations described herein, or a combination thereof. For example, one or more of the described blocks or components (e.g., blocks or components associated with RTT communications and sequence number estimation) represent software instructions that are executed by hardware such as a digital signal processor, an application-specific integrated circuit (ASIC), a set of logic gates, a field programmable gate array (FPGA), programmable logic device (PLD), a hardware accelerator, a parallel processor, or any other type of hardcoded or programmable circuit. As another example, one or more of the described blocks or components (e.g., blocks or components associated sequence number estimation) represent hardware in an application processor or signal processor.

FIG. 1 illustrates a mobile device 100 with a dual RTP stack architecture in accordance with some embodiments. The mobile device 100 is configured to perform handover between different types of radio access networks during an RTT session according to the techniques described herein. In the illustrated embodiment, the mobile device 100 includes a system on chip (SOC) 102 with an application processor (AP) 104, a vocoder 112, a connectivity interface (IF) 106, an SOC fabric 108, and a memory 110. The mobile device 100 also includes a WLAN and Bluetooth (BT) processor 120 configured generate and process communications over WLAN and Bluetooth and a cellular processor (CP) 122 configured to generate and process communications over cellular network such as LTE and 5G. Although not illustrated in FIG. 1, in some embodiments, the mobile device 100 includes additional components such as a power supply, additional processing components, additional memory, user interfaces such as a touch display, speaker(s), microphone(s), antennas for transmitting and receiving radio signals, and the like.

The mobile device 100 with dual RTP stack architecture is configured to support voice services over both cellular networks and WLAN networks. The CP 122 is configured to support cellular voice services via a real-time transport protocol (RTP) stack. The CP 122 also include a session initiation protocol (SIP) stack that is used for initiating, maintaining, and terminating communication sessions over cellular networks. WLAN voice services such as WiFi voice services are driven by the RTP stack in the AP 104. The AP 104 also includes an SIP stack that is used for initiating, maintaining, and terminating communication sessions over WLAN networks.

In addition to including the AP 104, the SOC 102 includes a dedicated audio component hosting the vocoder 112 which analyzes and synthesizes the human voice signal for audio data compression, multiplexing, voice encryption, and voice transformation, and a memory 110 or a computer storage medium for storing data or instructions to execute the techniques described herein. The SOC Fabric 108 provides an interface or signaling path for the different components of the SOC 102 to communicate with one another. The SOC 102 of the mobile device is connected with various radio interfaces. In the illustrated embodiment, the SOC 102 is connected to a WLAN/BT 120 interface to enable communications over WLAN and Bluetooth (BT) and to a Cellular Processor (CP) 122 interface to enable communications over cellular networks.

In some embodiments, the mobile device 100 does not include a standard interface to synchronize the RTP stack of the AP 104 with the RTP stack of the CP 122, i.e., the mobile device 100 is an unsynchronized dual RTP stack device. Conventional devices with an unsynchronized dual RTP stack typically experience a higher rate of RTT session discontinuities or drops during handovers due to large SN jumps that occur during the handover. In some embodiments, the techniques described herein allow for a mobile device 100 with an unsynchronized dual RTP stack to maintain RTT session continuity after a handover, thereby improving user experience.

FIG. 2 shows an example network 200 depicting a handover event for a mobile device 100 in accordance with various embodiments. In the illustrated example, the network 200 includes a first radio access network (RAN) node 202 that provides RAN coverage over area 212. The network 200 also includes a second RAN node 202 that provides RAN coverage over area 214. For example, the first RAN node 202 can be a WLAN access point that provides WLAN coverage over area 212 and the second RAN node 204 can be a cellular network node such as an eNodeB that provides LTE coverage over area 214 or a 5G node to provide 5G coverage over area 214.

In the illustrated embodiment, the network 200 triggers a handover between the WLAN access point 202 and the cellular network node 204 for providing network coverage to the mobile device 100 depending on a physical location of the mobile device 100 or a signal quality being reported by the mobile device 100. For example, in a first scenario, the mobile device 100 is initially connected to the network 200 via WLAN access point 202 and engaging in an RTT session with another device (not pictured). In some cases, the mobile device 100 is engaging in RTT communications over VoWiFi, for example. Based on the mobile device 100 moving farther away from the coverage area 212 of the WLAN access point 202 or a signal quality between mobile device 100 and the WLAN access point 202 deteriorating, the network 200 triggers a handover 222 from the WLAN access point 202 to the cellular network node 204. In another example, in a second scenario, the network 200 triggers a handover 224 from the cellular network node 204 to the WLAN access point 202 in a similar fashion.

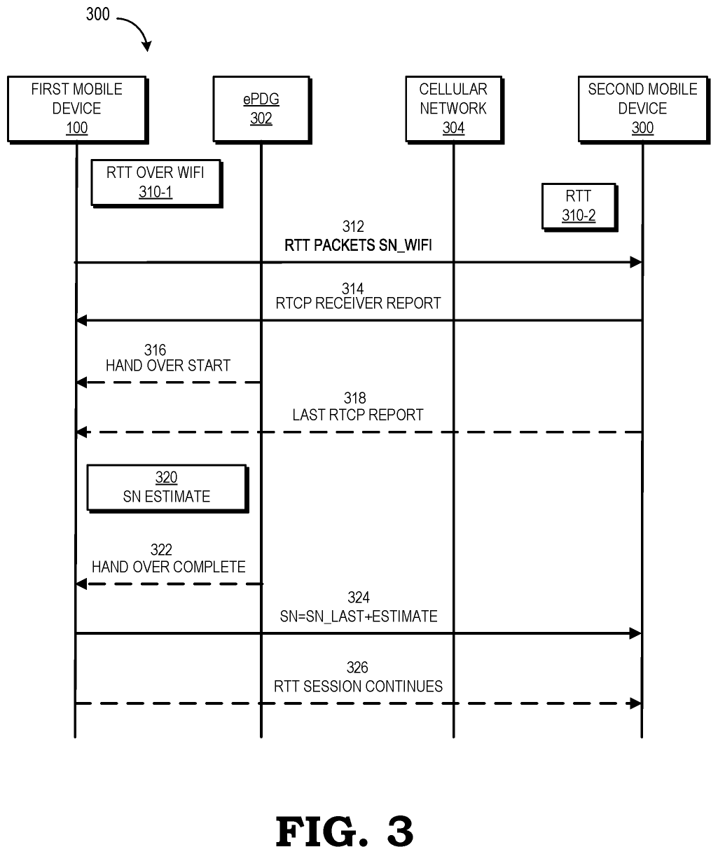

FIG. 3 shows an example of a message sequence chart (MSC) 300 to maintain RTT session continuity after a WiFi to cellular network handover in accordance with some embodiments. In the illustrated embodiment, the first mobile device 100 is engaged in an RTT session with a second mobile device 300 while the first mobile device 100 is initially connected to WiFi, where the first mobile device 100 has an unsynchronized dual RTP stack. MSC 300 also shows the Evolved Packet Data Gateway (ePDG) 302 which is responsible for interactions between an Evolved Packet Core (EPC) of cellular network such as LTE, for example, and a WLAN network such as WiFi. In addition, MSC 300 shows the wireless carrier's cellular network 304, e.g., an LTE network.

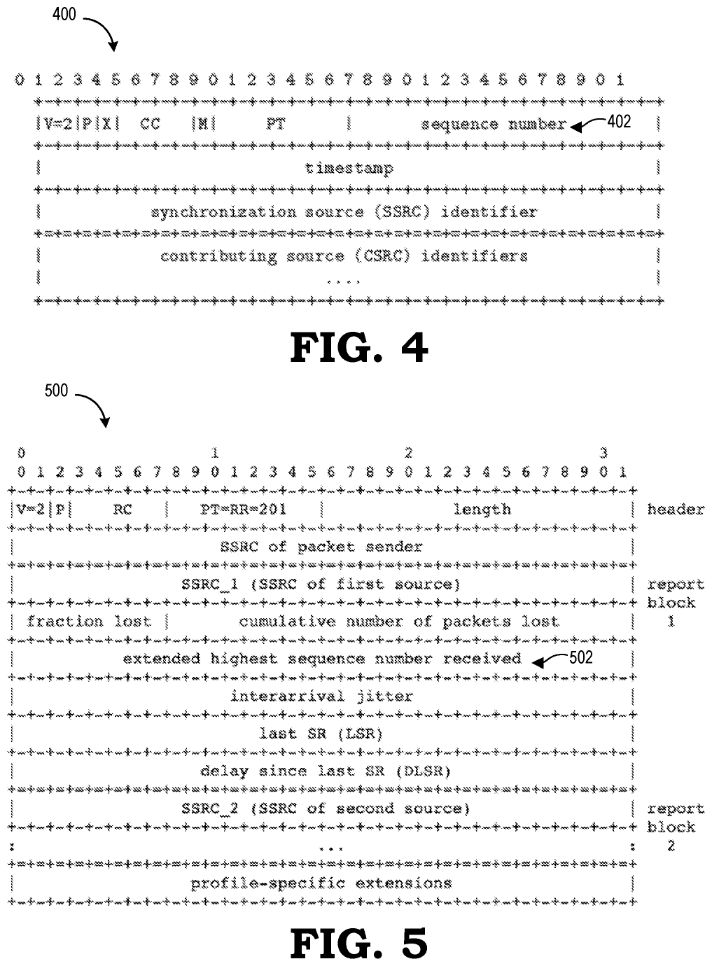

At 310, the RTT session is ongoing between the first mobile device 100 and the second mobile device 300 while the first mobile device 100 is connected to a WiFi network. Thus, the first mobile device 100 generates RTT over WiFi at message 310-1 and, at message 310-2, the second mobile device 300 receives the RTT generated by the first mobile device 100. At message 312, the first mobile device 100 generates RTT packets with a sequence number (SN) associated with the WiFi network. An example of an RTP packet header 400 with a sequence number 402 associated with the RTT packets is shown in FIG. 4. At message 314, the second mobile device 300 responds with an RTP Control Protocol (RTCP) receiver report. An example of an RTCP receiver report 500 is shown in FIG. 5. The RTCP receiver report 500 includes an “extended highest sequence number received” parameter 502.

At message 316, the ePDG 302 triggers a handover from VoWiFi to the cellular network 304. the first mobile device 100 continues to monitor for RTCP receiver reports from the second mobile device 300 in order to obtain the most recent “extended highest sequence number received” parameter, i.e., the most recent “extended highest sequence number received” parameter 502 of the RTCP receiver report 500 in FIG. 5. Thus, the first mobile device 100 continues to monitor for and receives the last RTCP receiver report 318 from the second mobile device 300 and extracts the “extended highest sequence number received” parameter from the last RTCP receiver report 318. Then, the CP RTP stack (e.g., corresponding to RTP stack of the CP 122 of mobile device 100 in FIG. 1) of the first mobile device 100 performs an initial sequence number (SN) estimate 320 after handover is to be completed to ensure RTT session continuity on the CN 304.

In some embodiments, the first mobile device 100 performs the SN estimate 320 which may be represented by the equation:

$$SN\_after \_HO = Latest\_SN \_before \_HO + SN Delay Estimate + 1 \qquad ( 1 )$$

where “SN_after_HO” is the estimate of the SN after handover (HO) is completed, “Latest_SN_before_HO” is the “extended highest sequence number received” parameter of the most recent RTCP receiver report (e.g., such as the one shown in FIG. 5), and the “SN Delay Estimate” is the estimate of the transmitted packets that have occurred but were not reported in the most recent RTCP receiver report. To compute the SN Delay Estimate, in some cases, the first mobile device 100 obtains the round trip delay (RTD) based on the time when an RTP packet was transmitted and the time of the last SN that was reported in the most recent RTCP receiver report. For example, RTP packets are transmitted every 20 milliseconds (ms) (this corresponds to the RTCP transmission period). Therefore, in some embodiments, the first mobile device 100 computes the SN Delay estimate by dividing the RTD by the RTCP Tx period (i.e., RTC/RTCP Tx period). In some cases, the RTD is in the range of 100 to 200 ms, so the SN Delay Estimate is in the range of 1 to 10 packets. In some embodiments, the first mobile device 100 sets the SN Delay Estimate to 1 when no typing is detected or when no RTT is being generated. The first mobile device 100 sets the default value, in some embodiments, of the SN Delay Estimate to 5 packets of delay. Additionally, since handovers typically support sequence number (SN) jumps of about 100 numbers, the accuracy of the estimate of the SN_after_HO does not need to be extremely precise.

The handover from the first radio access network to the second radio access network is then completed at 322, and the first mobile device transmits message 324 to indicate the estimated SN to the second mobile device 300. Then, at message 326, the RTT session continues based on the estimated SN. For example, in some embodiments, this includes inserting the estimated sequence number in an RTT packet transmitted over the cellular network 304.

MSC 300 shows an embodiment of handover from a WiFi network to a cellular network. In this case, the CP RTP stack (e.g., the RTP stack of the CP 122 of mobile device 100 of FIG. 1) of the first mobile device 100 performs the SN Estimate 320. In other embodiments, in the case of handover from a cellular network to a WiFi network, the AP RTP stack (e.g., the RTP stack of the AP 104 of mobile device 100 of FIG. 1) of the first mobile device 100 performs the SN Estimate 320. In either case, the first mobile device 100 is configured to perform an estimate of the initial sequence number associated with the radio access network after handover in order to ensure RTT session continuity even if the first mobile device 100 is an unsynchronized dual RTP stack device. In addition to maintaining RTT session continuity, other advantages include minimizing dependency on a modem vendor to include AP and CP interface changes.

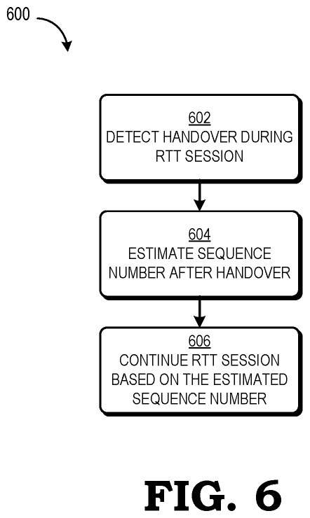

FIG. 6 shows an example of a method flowchart 600 for a mobile device to continue an ongoing RTT session after handover from a first radio access network to a second radio access network in accordance with some embodiments. In some embodiments, one or more of the boxes 602-606 of method flowchart 600 is performed by an AP RTP stack (e.g., the RTP stack of the AP 104 of mobile device 100 of FIG. 1) in case of handover from a cellular network to a WLAN or by the CP RTP stack (e.g., the RTP stack of the CP 122 of mobile device 100 of FIG. 1) in case of handover from WLAN to a cellular network.

At 602, the method includes detecting a handover during an RTT session while the mobile device is connected to a first radio access network. At 604, the method includes estimating a sequence number associated with the second radio access network after the handover (e.g., performing the SN estimate 320 of FIG. 3). At 606, the method includes continuing the RTT session on the second radio access network based on the estimated sequence number.

In some embodiments, a mobile device is configured to tune the default value of the SN Delay Estimate based on periodic SN delay evaluations. For example, the mobile device (such as mobile device 100 of FIGS. 1 and 2 or the first mobile device 100 of FIG. 3) compares the RTP transmission SNs in the transmitted packets against RTCP receiver reports to check whether the SN Delay Estimate is up to date. The periodicity of these checks is configurable and may depend on network conditions, device condition, a user profile, or the like.

In some embodiments, in the case of handover from cellular network to WiFi networks, the mobile device uses one or more transmission counters to update the system frame number (SFM). In such embodiments, this provides an alternative option or can be used as validation that the RTCP receiver report indicated the proper SN for the last received packet.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed is not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
detecting, for a first mobile device, a handover from a first radio access network to a second radio access network during a Real-Time Text (RTT) session between the first mobile device and a second device;
estimating a sequence number associated with the second radio access network in response to the handover; and
continuing the RTT session on the second radio access network based on the estimated sequence number.

2. The method of claim 1, wherein estimating the sequence number associated with the second radio access network after the handover comprises:
monitoring, by the first mobile device, one or more control protocol reports received from the second device via the first radio access network; and
based on one control protocol report of the one or more control protocol reports, acquiring a latest sequence number from the control protocol report.

3. The method of claim 2, wherein estimating the sequence number associated with the second radio access network after the handover comprises:
generating a delay estimate indicative of a number of transmitted packets which have not been reported in the one control protocol report; and
adding the delay estimate to the latest sequence number.

4. The method of claim 3, wherein the delay estimate is further based on a round trip delay associated with a real-time transport protocol (RTP) between the first mobile device and the second device.

5. The method of claim 4, wherein the delay estimate is further based on a RTP Control Protocol (RTCP) transmission period indicative of a time interval for transmitting RTP packets.

6. The method of claim 1, wherein the first radio access network is one of a cellular network or a wireless local area network (WLAN) and the second radio access network the other of a cellular network or a WLAN.

7. The method of claim 6, wherein an application processor of the first mobile device performs the estimating of the sequence number associated with the second radio access network after the handover and continues the RTT session on the second radio access network based on the estimated sequence number.

8. The method of claim 6, wherein a cellular processor of the first mobile device performs the estimating of the sequence number associated with the second radio access network after the handover and continues the RTT session on the second radio access network based on the estimated sequence number.

9. The method of claim 1, wherein continuing the RTT session on the second radio access network based on the estimated sequence number comprises inserting the estimated sequence number in an RTT packet transmitted over the second radio access network.

10. A mobile device comprising a processor to perform the method of claim 1.
